(19) United States
(12) Patent Application Publication
(10) Pub. No.: US 2009/0256824 A1
(43) Pub. Date: Oct. 15, 2009

(54) POINTER DEVICE FOR CAPACITIVE SENSITIVE TOUCH SCREENS

(75) Inventors: Richard HAINZL, Sollentuna (SE); Per-Ragnar HANSSON, Stockholm (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/101,283

(22) Filed: Apr. 11, 2008

(51) Int. Cl. G06F 3/033

(52) U.S. Cl. 345/179

(57) ABSTRACT

A passive pointer device, in shape of a stylus, for being used in conjunction with a capacitance sensitive touch screen for pointing, writing, drawing or others on the touch screen.

### TECHNICAL FIELD

The present invention relates in general to a pointer device for inputting information to an electronic device. More specifically, the invention relates to a stylus used in conjunction with a capacitance sensitive touch screen. The present invention also relates to electronic devices, such as mobile terminals, e.g., mobile telephones, personal digital assistants (PDAs), digital camera devices and/or handheld computers, including one or several such input devices.

### BACKGROUND ART

A variety of portable electronic devices, such as mobile terminals (e.g., mobile telephones, PDA:s, media players and/or handheld computers), are widely used today. Many of these devices have been developed to include different object positioning sensing methods and devices.

It is known in the field of touch sensitive data input screens, touch pads, that various object sensing and positioning determining technologies have been used.

As an example, pressure sensitive touch pads enabled any object which could be pressed against a touch pad surface at a localized point and then moved along the surface as a corresponding movement of a curser on a computer screen to write a message or input other data. A stylus is often integrated with the touch pad to provide a pointing device other than the finger tip, since the stylus provides certain advantages over the finger tip.

Capacitive touch screens or pads have been very popular. Good optical and mechanical performances in combination with good design possibilities make these touch screens very attractive. This technology is based on capacitance sensing through a glass screen. A transparent sensor film is placed behind the glass screen. Upon a finger touch on the screen a capacitance is created between the finger and the sensor film. A pattern is created on the sensor film in such a way that coordinates is provided which corresponds to the position of where the finger touches the screen. However, one drawback with this is that the use of a finger or other fairly big conducting objects is needed to detect an input. This excludes stylus input that is very commonly used with resistive touch pads.

Conductive or active styluses with batteries has been shown together with capacitive touch screens, however the size of these styluses are too big to be used in a mobile hand sets. It has also been shown to use other conductive material and induction technology, however this type is also too big. Active styluses often have to be re-charged or batteries have to be changed. Further, many of the conductive and/or active styluses of today are expensive.

### SUMMARY OF THE INVENTION

With the above and following description in mind, then, an aspect of some embodiments of the present invention is to provide a passive input device that can be used on a capacitive touch panel, which seeks to mitigate, alleviate or eliminate one or more of the above-identified deficiencies in the art and disadvantages singly or in any combination.

An aspect of the present invention relates to a pointer device for being used with a capacitance sensitive touch screen having a touch sensitive surface. The pointer device comprises a conductive pointer tip and a passive conductive element. Further, the conductive pointer tip is electrically connected to the passive conductive element for providing a capacitive disturbance on the touch sensitive surface when the pointer device touches the surface.

In one embodiment the passive conductive element may be a pressure sensing component.

In another embodiment the passive conductive element may be a capacitive component. The capacitive component may be a piezo electric element or a piezo electric film.

In a further embodiment the passive conductive element may be a resistive component.

In still a further embodiment the pointer device may comprise a casing for housing the pointer tip and the passive element. The casing may be a regular stylus.

The features of the above-mentioned embodiments can be combined in any combinations.

Some embodiments of the invention provide a pointer device for capacitive sensing touch screens. It is an advantage with some embodiments of the invention that they may allow for getting the advantages of a capacitive touch panel and still keep a stylus which may be used as a pointer on a capacitive sensing touch screen without any active components that needs to be changed. It is another advantage with some embodiments of the invention that they may allow for providing an improved user experience and a good looking mobile hand set with a slim pointer device. Another advantage with some embodiment of the present invention is that since a piezo element may be small and stacked, it may easily be built into a regular stylus. Still another advantage with some embodiment of the present invention is that if the user looses the pointer device of the present invention the user may still be able to use the finger as a pointer device.

### BRIEF DESCRIPTION OF THE DRAWINGS

Further objects, features and advantages of the present invention will appear from the following detailed description of the invention, wherein embodiments of the invention will be described in more detail with reference to the accompanying drawings, in which:

FIG. 1 illustrates a pointer device according to prior art;

FIG. 2 illustrates a pointer device according to an embodiment of the present invention;

FIG. 3a-b illustrates a pointer device according to an embodiment of the present invention.

### DETAILED DESCRIPTION

Embodiments of the present invention relate, in general, to the field of pointer devices used in conjunction with capacitive touch screens. A preferred embodiment relates to a passive pointer device, in shape of a stylus, used for pointing, writing, drawing or others on a capacitive touch screen.

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference signs refer to like elements throughout.

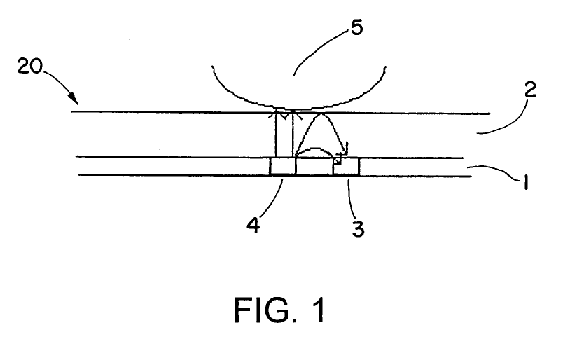

One example of a capacitive touch screen 20 is shown in FIG. 1. The touch screen may comprise a substrate (not shown) on which a conductive sensing layer 1 is coated. The substrate may be coated with a conductive layer, typically indium tin oxide or, alternatively, copper that is capable of conducting a continuous electrical current across the conductive layer. The capacitive touch screen 20 may therefore exhibit a controlled field of stored electrons in both horizontal and vertical axes—it achieves capacitance. The human body is also an electronic device which has stored electrons and, therefore, also exhibits capacitance. When the ‘normal’ capacitance field (i.e. reference state) of the capacitive touch screen 20 is altered by another capacitance field, e.g., someone's finger 5, electronic circuits of capacitive touch screen 20 may measure the resultant distortion in the sine wave characteristics of the reference capacitance field or in another common way. A controller included in the electronic device, in which the touch screen 20 is included may receive the information of the resultant distortion in the sine wave characteristics of the reference field for operational processing. The capacitive touch screen 20 can be touched by a bare finger or with a conductive device 5 being held by a bare hand. However, the capacitive touch screen 20 is not affected by outside objects such as a tip of a pencil or other similar object.

With reference to FIG. 1, a capacitive touch screen 20 may detect a fairly large conducting object such as a finger 5 or other large conductive objects. The transparent sensor layer 1 is placed behind a glass screen 2. Upon a finger touching the screen a capacitance is created between the finger 5 and the sensor layer 1. A pattern, a sensing grid, is created on the sensor layer 1 in such a way that coordinates may be provided which corresponds to the position of where the finger touches the screen.

The sensing layer 1 includes driving lines 4 that supply voltage and detection lines 3 which detect voltage changes. The finger 5 acts as ground when touching the screen close to the sensing layer 1 and an Electrical magnetic field, E-field, is generated between the driving line 4 and the finger 5. This E-field is detected by the detecting line 3 which generates a signal. By scanning several lines in the sensing grid on the sensing layer 1 the present position of the finger on the screen may be calculated, i.e. by a CPU in the electronic device comprising the touch screen.

The herein below presented various embodiments of the invention uses a pressure sensing device and a conductive contact device 7, 8. As will be described further herein, this use of both a pressure sensing device and a conductive contact device provides for an improved pointer device, which is suitable for being used in conjunction with a capacitive touch screen.

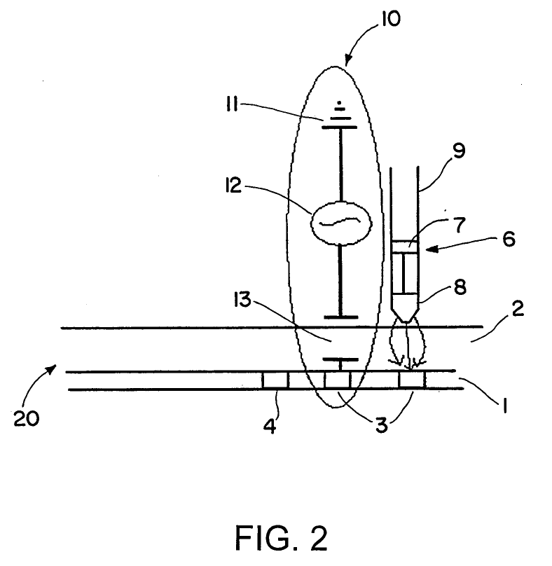

FIG. 2 illustrates a first embodiment of a pointer device 6 according to the invention. The pointer device comprises a conductive contact device 8 and a pressure sensing device 7 mounted in a casing 9, such as a regular stylus casing or the like.

In the embodiment shown in FIG. 2, the contact device 8 is a metal pen-tip. The contact device 8 is configured to provide a capacitance disturbance in the sensing layer 1 in a touch screen 20 when the user touches or presses the contact device 8 against the touch screen.

The metal pen-tip may be covered by a cover layer, to protect the touch screen when using the pointer device. The cover layer may be made of, e.g., plastic, rubber, etc.

The pressure sensing device 7 comprised in this embodiment is in the form of a piezo element. A piezo element may be a ceramic component or a film with piezo electric properties.

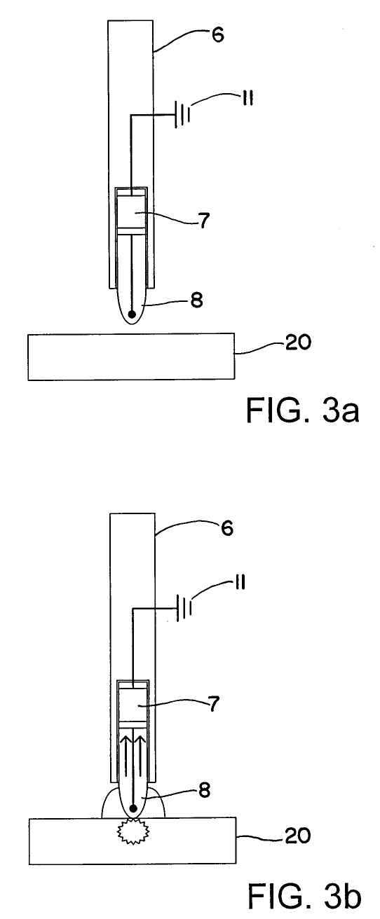

The pen tip 8 and the piezo element 7 are electrically connected. As can be seen in FIGS. 3a and 3b, the piezo element 7 is positioned relative to the pen-tip 8 such that, upon depression of the pointer device 6 against the touch screen 20, the pen-tip 8 actuates towards the piezo element 7, as illustrated by the arrows in FIG. 3b, for depressing the piezo element 7. The piezo element 7 generates voltage upon mechanical impact and the pen-tip will be charged by the piezo element and a capacitance between the pen-tip 8 and the detecting line 3 in the sensor layer 1 of the touch screen is created. The applied voltage on the pen tip 8 generates an E-field over the capacitance sufficient to detect a voltage change on the detecting line 3 and thus generate a signal. The grid of detecting lines is scanned as before which gives position of the stylus.

In a very simplified electrical model 10, as shown in FIG. 2, the piezo element within the stylus may be seen as a voltage source 12 and the gap between sensor layer 1 and pen-tip 8 may be seen as a capacitance source 13 and the user holding the pointer device act as ground 11.

In use, a user of the tip of the pointer device is placing the tip in contact with the touch screen surface and a capacitive disturbance is created on the touch screen. Additionally, the user of the pointer device is moving the pointer device over the touch screen, such as when the user write or “draw” on the touch screen, and the touch screen is sensing the pointer device moving across the screen and recognizing characters, numbers or other data inputs by using appropriate software and hardware.

The pointer device may also comprise some additional passive electrical components or some mechanical components, e.g. mechanical spring, for improving/optimizing the performance of the pointer device.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the following claims.

1. A pointer device for being used with a capacitance sensitive touch screen having a touch sensitive surface, the pointer device comprising:
a conductive pointer tip; and
a passive conductive element,
wherein said conductive pointer tip is electrically connected to said passive conductive element for providing a capacitive disturbance on said touch sensitive surface when said pointer device touches said surface.

2. The pointer device according to claim 1, wherein said passive conductive element is a pressure sensing component.

3. The pointer device according to claim 1, wherein said passive conductive element is a capacitive component.

4. The pointer according to claim 3, wherein said capacitive component is a piezo electric element.

5. The pointer according to claim 3, wherein said capacitive component is a piezo electric film.

6. The pointer device according to claim 1, wherein said passive conductive element is a resistive component.

7. The pointer device according to claim 1, wherein said device further comprising a casing for housing said pointer tip and said passive element.

8. The pointer device according to claim 8, wherein the casing is a regular stylus.
